(19) United States
(12) Patent Application Publication
(10) Pub. No.: US 2010/0262921 A1
(43) Pub. Date: Oct. 14, 2010

(54) Originator-Specified Constraints For Message Responses

(75) Inventors: David Gray Boyer, Oceanport, NJ (US); Ronald J. Fernandez, Palo Alto, CA (US); Ronald D. Stelter, San Ramon, CA (US)

Correspondence Address: Avaya;DEMONT & BREYER, LLC, 100 COMMONS WAY, STE 250, HOLMDEL, NJ, 07733, US

(73) Assignee: AVAYA INC., Basking Ridge, NJ (US)

(21) Appl. No.: 12/423,471

(22) Filed: Apr. 14, 2009

(51) Int. Cl. G06F 3/048; H04W 4/12; G06F 15/16

(52) U.S. Cl. 715/752; 455/466; 709/207

(57) ABSTRACT

A mechanism by which the originator of a message can establish one or more mandatory characteristics for a response is disclosed. In the illustrative embodiment, the originator of a message can specify a priority for responses to the message, and all responses will automatically be forced to have that priority. In accordance with the illustrative embodiment, the priority requirement is enforced by automatically setting the appropriate priority level in a graphical user interface (GUI) by which the recipient responds to the message, and making this portion of the GUI inactive so that the priority cannot be changed. The illustrative embodiment also enables the originator to specify other mandatory characteristics for responses, including what telecommunications terminal(s) the response will be directed to (e.g., cell phone, personal computer, etc.), and how the response will be sent (e.g., email, a short message service [SMS] text message, instant messaging [IM], etc.).

### FIELD OF THE INVENTION

The present invention relates to telecommunications in general, and, more particularly, to messaging systems.

### BACKGROUND OF THE INVENTION

In many communications systems (e.g., email systems, voice mail systems, etc.) the originator of a message (e.g., an email message, a Short Message Service (SMS) message, a voice mail message, etc.) can specify characteristics of the message such as a message subject, a message priority, one or more destinations for the message (e.g., an email address, a telephone number of a cell phone or smartphone, an Internet Protocol address, etc.), and so forth.

### SUMMARY OF THE INVENTION

The present invention provides a mechanism by which the originator of a message can establish one or more mandatory characteristics for a response to the message. In particular, in accordance with the illustrative embodiment of the present invention, the originator of a message can specify a priority for responses to the message, and all responses to the message will automatically be forced to have that priority, without the ability of the responding user to change or override that priority. For example, a user might send a message that itself has no priority, but might also specify that any response to the message must have a high priority, and the mechanism of the illustrative embodiment will enforce this requirement when any recipient of the message composes a response. Similarly, a user might send a message that has a low priority and specify that any response to the message must have a high priority.

In accordance with the illustrative embodiment, the priority requirement is enforced by automatically setting the appropriate priority level in a graphical user interface (GUI) by which the recipient responds to the message, and making this portion of the GUI inactive so that the priority cannot be changed by the responding user. The illustrative embodiment of the present invention also enables the originator of a message to specify other mandatory characteristics for responses, including what telecommunications terminal(s) the response will be directed to (e.g., the originator's cell phone, the originator's personal computer, the originator's Blackberry®, etc.), and via what method(s) the response will be sent (e.g., via email, via a short message service [SMS] text message, via instant messaging [IM], etc.).

The illustrative embodiment comprises: receiving (i) a message that has no priority, and (ii) a priority P; and forcing any response to said message to have said priority P.

### BRIEF DESCRIPTION OF THE DRAWINGS

FIG. 1 depicts a flowchart of a first method in accordance with the illustrative embodiment of the present invention.

FIG. 2 depicts illustrative graphical user interface (GUI) 200 for composing responses to messages, in accordance with the illustrative embodiment of the present invention.

FIG. 3 depicts a flowchart of a second method in accordance with the illustrative embodiment of the present invention.

### DETAILED DESCRIPTION

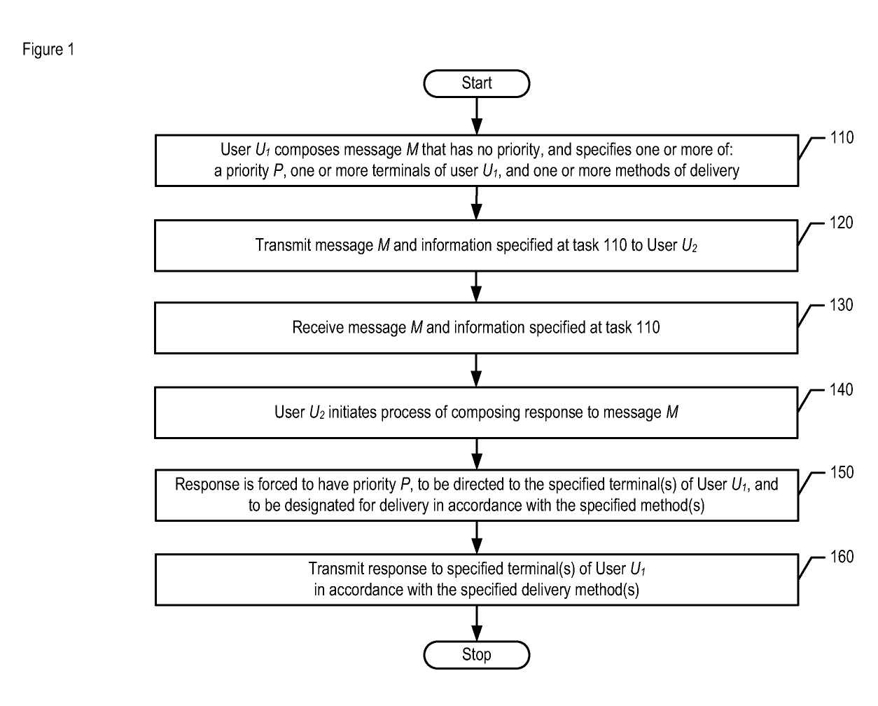

FIG. 1 depicts a flowchart of a first method in accordance with the illustrative embodiment of the present invention.

At task 110, user U₁ composes a message M that has no priority, and specifies one or more of: a priority P, one or more terminals of user U₁ (e.g., user U₁'s cell phone, user U₁'s personal computer, user U₁'s Blackberry®, etc.), and one or more methods of delivery (e.g., email, short message service [SMS] text message, instant messaging [IM], etc.), in well-known fashion.

At task 120, message M, along with the information specified at task 110, are transmitted to user U₂, in well-known fashion.

At task 130, message M and the information specified at task 110 are received, in well-known fashion.

At task 140, user U₂ initiates the process of composing a response to message M (e.g., clicking on a “reply” button in a graphical user interface [GUI], etc.), in well-known fashion.

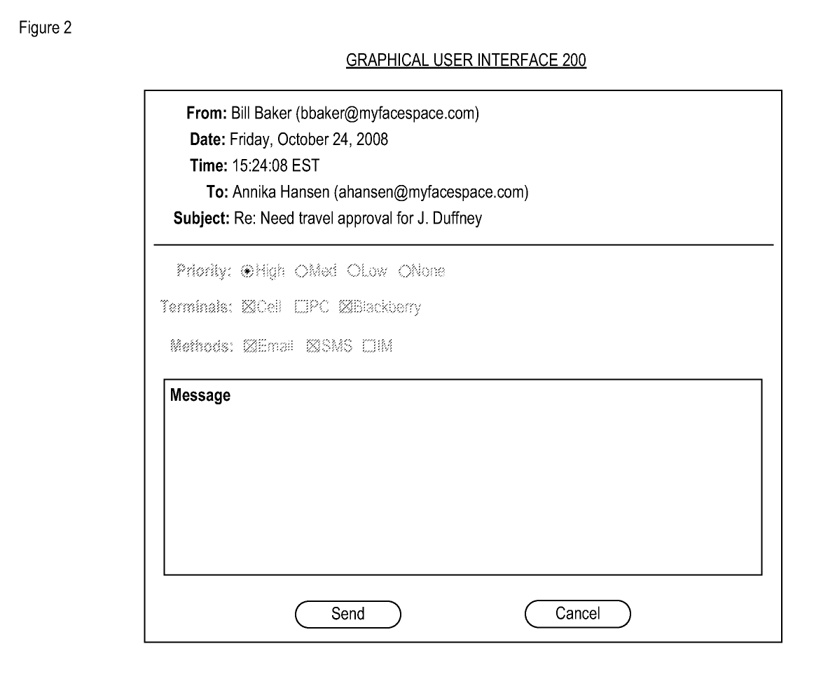

At task 150, the response is forced to have priority P (if priority P was specified), to be directed to the specified terminal(s) of user U₁ (if so specified), and to be designated for delivery in accordance with the specified method(s) (if so specified). As will be appreciated by those skilled in the art, there are a variety of ways in which this forcing might be accomplished. In accordance with the illustrative embodiment, the appropriate priority level, destination terminal(s), and delivery method(s) are automatically set in a graphical user interface (GUI) by which the recipient responds to the message, and the pertinent portions of the GUI are rendered inactive so that the user cannot change any of this information. This particular approach is described below and with respect to FIG. 2.

At task 160, the response is transmitted to the specified terminal(s) of user U₁ in accordance with the specified delivery method(s), in well-known fashion.

FIG. 2 depicts illustrative graphical user interface (GUI) 200 for composing responses to messages, in accordance with the illustrative embodiment of the present invention. As shown in FIG. 2, graphical user interface (GUI) 200 comprises a radio button widget for specifying the priority of the response, a checkbox widget for specifying which terminal(s) the response is directed to, and a checkbox widget for specifying the delivery method(s) for the response. In accordance with the illustrative embodiment, the states of these three widgets are set in accordance with the information specified by user U₁, and the three widgets are set to be inactive (as indicated by their grayed-out rendering) so that a user cannot change their states by clicking on the radio buttons or checkboxes.

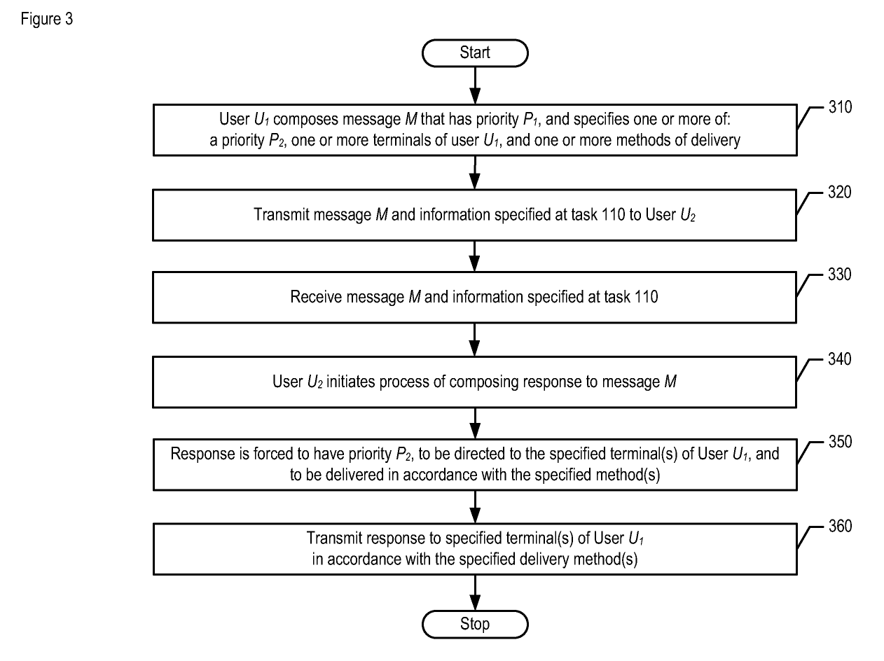

FIG. 3 depicts a flowchart of a second method in accordance with the illustrative embodiment of the present invention. The method of FIG. 3 is similar to the method of FIG. 1, with the exception that the originator composes a message that does have a priority (rather than no priority) but that is different than the priority specified for responses to the message.

At task 310, user U₁ composes a message M that has priority P₁, and specifies one or more of: a priority P₂, one or more terminals of user U₁ (e.g., user U₁'s cell phone, user U₁'s personal computer, user U₁'s Blackberry®, etc.), and one or more methods of delivery (e.g., email, short message service [SMS] text message, instant messaging [IM], etc.), in well-known fashion.

At task 320, message M, along with the information specified at task 310, are transmitted to user U₂, in well-known fashion.

At task 330, message M and the information specified at task 310 are received, in well-known fashion.

At task 340, user U₂ initiates the process of composing a response to message M (e.g., clicking on a “reply” button in a graphical user interface [GUI], etc.), in well-known fashion.

At task 350, the response is forced to have priority P₂ (if priority P₂ was specified), to be directed to the specified terminal(s) of user U₁ (if so specified), and to be designated for delivery in accordance with the specified method(s) (if so specified). In accordance with the illustrative embodiment, this forcing is accomplished via the graphical user interface (GUI) mechanism described above and with respect to FIGS. 1 and 2. As will be appreciated by those skilled in the art, some other embodiments of the present invention might achieve this result via an alternative technique, and it will be clear to those skilled in the art, after reading this disclosure, how to make and use such embodiments of the present invention.

At task 360, the response is transmitted to the specified terminal(s) of user U₁ in accordance with the specified delivery method(s), in well-known fashion.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A method comprising:
receiving
(i) a message that has no priority, and
(ii) a priority P; and
forcing any response to said message to have said priority P.

2. The method of claim 1 further comprising presenting a graphical user interface that
(a) is for composing a response to said message, and
(b) has an element that indicates priority and is fixed at said priority P.

3. The method of claim 1 further comprising:
receiving (iii) a description of how a response to said message should be sent; and
transmitting a response to said message in accordance with said description.

4. The method of claim 3 wherein said description indicates one or more telecommunications terminals to which a response to said message should be sent.

5. The method of claim 1 further comprising:
receiving (iii) a description of how a response to said message should be sent; and
forcing any response to said message to be sent in accordance with said description.

6. The method of claim 5 wherein said description indicates one or more telecommunications terminals to which a response to said message should be sent

7. A method comprising:
receiving
(i) a message that has a first priority, and
(ii) a second priority P that is different than said first priority; and
forcing any response to said message to have said second priority P.

8. The method of claim 7 further comprising:
receiving (iii) a description of how a response to said message should be sent; and
forcing any response to said message to be sent in accordance with said description.

9. The method of claim 8 wherein said description indicates one or more telecommunications terminals to which a response to said message should be sent.

10. The method of claim 9 further comprising presenting a graphical user interface that
(a) is for composing a response to said message, and
(b) has an element that
(1) indicates which devices to send said response to, and
(2) is fixed at said one or more telecommunications terminals.

11. A method comprising transmitting
(i) a message that has no priority, and
(ii) a priority P that indicates what the priority of any response to said message should be.

12. The method of claim 11 further comprising transmitting (iii) a description of how a response to said message should be sent.

13. The method of claim 12 wherein said description indicates one or more telecommunications terminals to which a response to said message should be sent.

14. The method of claim 12 further comprising forcing any response to said message to be sent in accordance with said description.

15. The method of claim 11 further comprising forcing any response to said message to have said priority P.

16. A method comprising transmitting
(i) a message that has a first priority, and
(ii) a second priority P that is different than said first priority and that indicates what the priority of any response to said message should be.

17. The method of claim 16 further comprising transmitting (iii) a description of how a response to said message should be sent.

18. The method of claim 17 wherein said description indicates one or more telecommunications terminals to which a response to said message should be sent.

19. The method of claim 17 further comprising forcing any response to said message to be sent in accordance with said description.

20. The method of claim 16 further comprising forcing any response to said message to have said second priority P.
